(19) United States
(12) Patent Application Publication
(10) Pub. No.: US 2006/0041117 A1
(43) Pub. Date: Feb. 23, 2006

(54) Process for the preparation of cellulose derivatives containing amino groups

(76) Inventors: Jurgen Engelhardt, Bad Fallingbostel (DE); Meinolf Brackhagen, Walsrode (DE); Klaus Nachtkamp, Walsrode (DE); Wolfgang Koch, Bomlitz (DE); Thomas Schulze, Rudolstadt (DE); Frank Meister, Rudolstadt (DE)

Correspondence Address: BAYER MATERIAL SCIENCE LLC, 100 BAYER ROAD, PITTSBURGH, PA, 15205, US

(21) Appl. No.: 11/184,093

(22) Filed: Jul. 19, 2005

(30) Foreign Application Priority Data
Jul. 23, 2004 (DE) 1020040358699

(51) Int. Cl. C08B 11/00

(52) U.S. Cl. 536/43

(57) ABSTRACT

A process is described for the preparation of cellulose derivatives containing amino groups that involves reacting, in the presents of water as a reaction medium, alkali cellulose or alkali cellulose derivatives with reagents represented by the following formula,
X—(CH₂)ₙ—NR₁R₂
in which: X is selected from the group consisting of chlorine, bromine, iodine and a sulfonic acid radical R′SO₃, in which R′ is an aromatic radical or an aliphatic radical; n is at least 2; and R₁ and R₂ independently of each other are selected from the group consisting of aliphatic substituents, branched alkyl substituents, cyclic alkyl substituents, aryl substituents, aryl substituents substituted by heteroatoms, H, and R₁ and R₂ together form a ring with the nitrogen. In the process, the mole ratio of cellulose to water, of said reaction medium, is 1:5 to 1:40 mol water per mol of anhydroglucose unit (AGU). Amino functional cellulose derivatives prepared in accordance with the method of the present invention are useful in cosmetic formulations and aqueous paper treatment compositions.

### CROSS REFERENCE TO RELATED PATENT APPLICATION

The present patent application claims the right of priority under 35 U.S.C. §119(a)-(d) of German Patent Application No. 102004035869, filed Jul. 23, 2004.

### FIELD OF THE INVENTION

The invention relates to a process for the preparation of cellulose derivatives containing amino groups by the reaction of alkali cellulose with reagents containing amino groups, it being possible to obtain water-soluble or water-dispersible reaction products in one reaction step starting from unsubstituted cellulose or cellulose derivatives.

### BACKGROUND OF THE INVENTION

Especially chitosan—2-amino-2-deoxycellulose—has a broad range of possible uses, inter alia as an acid-stable thickener in cosmetic formulations, as paper auxiliaries, chelating agents and flocculants. However, the isolation of this natural polysaccharide is an expensive process, which is reflected in high product prices. The high price has hitherto hampered the wide use of chitosan and polysaccharide derivatives.

It is known that cellulose and its derivatives, principally cellulose ethers containing hydroxyethyl groups, can be converted to cellulose derivatives containing amino groups, e.g. by reaction with aminoalkyl chlorides of the general formula Cl—(CH₂)ₙ—NR₂. The necessary thorough mixing of the batch is assured by the use of comparatively large amounts of organic solvents, as described e.g. in U.S. Pat. No. 2,623,042. The degrees of etherification achieved here are only low in most cases and the amount of unwanted by-products is high.

DE-A 1 946 722 suggests that this problem can be counteracted by the use of kneaders. In this case predominantly already water-soluble cellulose derivatives were kneaded in a solvent/water mixture and reacted with N-(2-chloroethyl)-N,N-diethylammonium chloride to achieve degrees of substitution of 0.3 to 1.0 per anhydroglucose unit. The disadvantage here, however, is that safety when handling combustible and volatile organic solvents (primarily peroxide-forming dioxane in the cited patent) in the industrial-scale reaction can only be assured by increased expenditure.

The work-up and recovery of aqueous solvents and solvent mixtures demands high investment, e.g. in distillation columns, and incurs disposal costs, e.g. for distillation residues. In addition, the use of combustible solvents carries an increased risk of fire and explosion.

### SUMMARY OF THE INVENTION

The object of the invention was therefore to provide an environmentally friendly, safe and cost-effective process for the preparation of cellulose derivatives containing amino groups.

The invention therefore provides a process for the preparation of cellulose derivatives containing amino groups by the reaction of alkali cellulose or alkali cellulose derivatives with reagents of the general formula
X—(CH₂)ₙ—NR₁R₂
in which,
X is chlorine, bromine, iodine or a sulfonic acid radical R′SO₃, R′ being an aromatic or aliphatic radical comprising 1-24 C-Atoms, e.g. Methyl, p-Toluyl,
n must be at least 2, and
the radicals R₁ and R₂ independently of one another are aliphatic or branched or cyclic alkyl or aryl substituents optionally substituted by heteroatoms, or H, or two radicals R₁ and R₂ can form a ring together with the nitrogen, R₁ and R₂ independently comprising 1-24 C-Atoms,
characterized in that water is used as the reaction medium and the ratio of cellulose to water is 1:5 to 1:40 mol per mol of anhydroglucose unit (AGU).

### DETAILED DESCRIPTION OF THE INVENTION

The process according to the invention makes it possible to avoid the disadvantages described. It has been found, surprisingly, that it is possible totally to dispense with the use of organic solvents during the reaction. According to the invention, water is used as the reaction medium. Despite the expected increase in hydrolysis of the reagents, the yields are surprisingly so good that water-soluble or at least water-dispersible cellulose derivatives can be prepared in one step from cellulose. Dispensing with organic solvents also considerably simplifies the work-up of the batches. The products obtained contain no residues of organic solvents used in the preparation, e.g. dioxane.

Cellulose of very diverse origin and property profiles can be used in the process according to the invention, preference being given to mechanically comminuted cellulose (beech, spruce, pine, eucalyptus, cotton), e.g. in the form of shavings, fibres or powder.

Cellulose derivatives can also be used, examples being carboxymethyl, hydroxyethyl, hydroxypropyl, methyl and ethyl cellulose and polysaccharides with mixed carboxymethyl, hydroxyethyl, hydroxypropyl, methyl and ethyl substituents. Methyl cellulose, hydroxyethyl cellulose, methyl hydroxyethyl cellulose, ethyl cellulose, ethyl hydroxyethyl cellulose, hydroxypropyl cellulose, methyl hydroxypropyl cellulose and ethyl hydroxypropyl cellulose are particularly preferred.

It is preferable to use a water-insoluble cellulose ether or a cellulose ether with a thermal flocculation point in water.

The overall degree of substitution of the cellulose derivatives used for the reaction is preferably between 0.01 and 4 and particularly preferably between 0.1 and 3. The mean degree of substitution of alkyl substituents (DS_{alkyl}) is between 0 and 2.5 and preferably between 0 and 1.7. The molar degree of substitution of hydroxyalkyl substituents (MS_{hydroxyalkyl}) is between 0 and 3.5 and preferably between 0 and 2.5.

Suitable etherifying agents are compounds of the general formula
X—(CH₂)ₙ—NR₁R₂
in which
X is a leaving group, preferably chlorine, bromine, iodine or a sulfonic acid radical R′SO₃, R′ being an aromatic or aliphatic radical, comprising 1-24 C-Atoms e.g. para-toluyl or methyl,
n must be at least 2, and
the radicals R₁ and R₂ independently of one another are aliphatic or branched or cyclic alkyl or aryl substituents optionally substituted by heteroatoms, or H. Two radicals R₁ and R₂ can form a ring together with the nitrogen, R₁ and R₂ independently comprising 1-24 C-Atoms,
X is particularly preferably chlorine.

Examples of etherifying reagents to be used according to the invention are N-2-chloroethyldiisopropylamine, N-2-chloroethyldiethylamine, N-3-chloropropyldiethylamine, N-2-chloroethyldimethylamine and N-2-chloropropyldimethylamine. The radicals R₁ and R₂ can form a cyclic radical together with the nitrogen. Examples of etherifying reagents used according to the invention in which two radicals R₁ and R₂ form a ring together with the nitrogen are N-2-chloroethylpyrrolidine, N-2-chloroethylpiperidine and N-2-chloroethylmorpholine. The etherifying reagents can be used in the form of the ammonium salts, preferably a hydrochloride. It is possible to use either the solid or a solution of e.g. 65 wt. % or 50 wt. % in water or another solvent.

It is preferable to use N-2-chloroethyldiisopropylamine hydrochloride and N-2-chloroethyldiethylamine hydrochloride.

About 0.1-3 mol, preferably about 0.3-2 mol and particularly preferably about 1-2 mol of etherifying reagent are used per mol of anhydroglucose if cellulose is used as the starting material.

If a cellulose derivative is used, 0.01-1.5 mol, preferably. 0.1-1 mol and particularly preferably 0.1-0.8 mol of etherifying reagent per mol of anhydroglucose is sufficient.

Before the reaction, the cellulose or cellulose derivative is alkalized with an aqueous solution of about 5-60 wt. % and preferably 30-55 wt. % of a base, preferably sodium hydroxide. The alkalization can be carried out directly in the reaction apparatus.

Also before the reaction, for example, the cellulose or cellulose derivative can be treated with a 5-60 wt. % aqueous solution of a base, preferably sodium hydroxide, and stirred for 10-120 min at room temperature. This is followed by squeezing-off to a definite residual moisture content. The cellulose activated in this way, e.g. alkali cellulose or a cellulose optionally swollen with ammonium hydroxides, or an activated cellulose derivative is then transferred to the reaction apparatus. Apart from cellulose, water-insoluble cellulose derivatives are also suitable for this form of activation.

In principle, it is also possible to use e.g. tetraalkylammonium hydroxides or sodium carbonate as the base, but it is preferable to use alkali metal hydroxides, particularly sodium hydroxide. Part of the base can be added as the solid.

Preferably at least 0.1 equivalent and particularly preferably at least 0.3 equivalent of base is used per mol of etherifying reagent. The amount of base used per mol of etherifying reagent should be at most 2 equivalents, preferably at most 1.5 mol and, in one particularly preferred embodiment, at most 1.2 mol.

The amount of base has to be increased accordingly if the etherifying reagent is used in the form of an ammonium salt, e.g. as the hydrochloride. In that case it is necessary additionally to introduce at least an equimolar amount of base, based on the ammonium salt, in order to liberate the amine from the ammonium salt, e.g. from the hydrochloride.

The ratio of cellulose to water should be 1:5 to 1:40 mol per mol of anhydroglucose unit and preferably between 1:10 and 1:30 parts by weight.

The reaction mixture is treated at a temperature of 15-95° C. for a period of 30 min-12 h, the chosen parameters preferably being as follows: 40-80° C. and 1-4 h.

To avoid and minimize a molecular weight degradation, the reaction can be carried out totally or partially under an inert gas, e.g. nitrogen or argon.

Suitable reaction apparatuses are known to those skilled in the art and can be determined by sizing experiments. The apparatuses should allow thorough mixing and heating of the reaction material.

Particularly suitable reaction apparatuses are e.g. kneaders based on a divided trough kneading chamber in which two often Z-shaped or sigma-shaped kneading blades rotate, optionally scraping one another, and cover almost the whole of the kneading space. High compressive, tensile and shear forces prevail overall in the kneading material due to the blade surfaces moving alternately closer together and further apart. This also enables highly viscous substances to be mixed thoroughly. [Ramesh R. Hemrajani in: Kirk-Othmer Encyclopedia of Chemical Technology, “Mixing and Blending; 12. Mixing of Dry Solids and Pastes”; John Wiley & Sons, 1995. DOI: 10.1002/0471238961.1309240908051318.a01, Article Online Posting Date: Dec. 4, 2000.]

The reaction batch is taken up in water or a solvent/water mixture, optionally neutralized washed with a suitable solvent, dried and optionally ground.

Suitable solvents for washing the product are those in which the product swells only a little or not at all. In the process according to the invention, cellulose derivatives containing amino groups are preferably purified with water if neutralization is omitted. Provided the filtrate has a pH of >7 and preferably >8 (measured in a 1 wt. % aqueous solution), the products swell or dissolve only slightly. Further washing can then be carried out with optionally aqueous, organic solvents or solvent mixtures, e.g. acetone, if desired. The product can then be processed further in the form of the free amine or completely or partially converted to the ammonium form with an acid and then processed further.

If desired, the reaction batch can also be treated, after the reaction, with an acid taken from the class comprising mineral acids or organic acids, preferably with hydrochloric acid. It is then advisable to carry out further washing with optionally aqueous, organic solvents or solvent mixtures, e.g. aqueous acetone. If the product is neutralized in this way, its pH is preferably 7-4 and particularly preferably about 6.5-5.

If required, the reaction product can be subjected to a further reaction of the same type without special purification, in order to increase the nitrogen content and hence the DS. A further possibility, according to the method described in the process according to the invention, is a mixed etherification with different etherifying reagents containing amino groups.

The process according to the invention is distinguished by a simple procedure and mild treatment of the cellulose. It is universally applicable to a large number of celluloses. Cellulose derivatives containing amino groups with degrees of substitution of between 0.5 and 1.5 can be obtained from unsubstituted celluloses in one reaction step. By dispensing with organic solvents, the use of explosion-proof apparatuses is superfluous in most cases.

The invention also provides cellulose derivatives containing amino groups which

a) contain substituents of the type —(CH₂)ₙ—NR₁R₂, bonded to the cellulose or a side chain, e.g. hydroxyalkyl chain, in which n is at least 2 and the radicals R₁ and R₂ independently of one another are aliphatic or branched or cyclic alkyl or aryl substituents optionally substituted by heteroatoms, or H, or two radicals R₁ and R₂ can form a ring together with the nitrogen, R₁ and R₂ independently comprising 1-24 C-Atoms,

b) contain alkyl substituents of the type R₃, R₃ preferably being —(CH₂)ₘ—CH₃, where m=0-3 and DS_{alkyl} is >0.1,

c) contain hydroxyalkyl substituents preferably from the group comprising hydroxyethyl, hydroxypropyl and hydroxybutyl, MS_{hydroxyalkyl} being >0.1, and

d) have an overall degree of substitution (sum of the individual degrees of substitution) of the substituents —(CH₂)ₙ—NR₁R₂, R₃ and hydroxyalkyl of between 0.8 and 2.5, determined from the nitrogen content [for substituents —(CH₂)ₙ—NR₁R₂] or after Zeisel cleavage [DS_{alkyl} for substituents R₃ and hydroxyalkyl].

The resulting cellulose derivatives containing amino groups can have a variety of uses, e.g. in cosmetic formulations, especially hair care products and shampoos. They can also be used in water treatment, especially as flocculation aids, or in paper manufacture, especially as retention aids. These indicated uses are also provided by the present invention.

### EXAMPLE 1

243 g (1.5 mol) of ground spruce sulfite pulp containing atmospheric moisture are alkalized in 5 l of 24% sodium hydroxide solution, squeezed off to an AGU:NaOH:water ratio of 1:4:29 and transferred to a horizontal kneader of 5 l capacity. After heating to 65° C., a solution of 600 g (3 mol) of N,N-diisopropyl-aminoethyl chloride hydrochloride in 323 g of water (65% solution) is added with intense kneading, and the kneading is continued for a further 3 h. This gives a reactant ratio AGU:NaOH:agent:water of 1:4:2:40 in the liquor. The reaction product formed is separated from the excess reaction liquid by suction and washed with warm water until the pH of the effluent wash water remains constant. The white powder obtained after drying has a nitrogen content of 5.80% (DS=1.14).

### EXAMPLE 2

5 l of 25% sodium hydroxide solution are poured over 243 g (1.5 mol) of pulp and the mixture is stirred for 1 h at room temperature. It is then squeezed off until the anhydroglucose:NaOH:water ratio is 1:4:20. 491 g (3 mol) of N,N-diisopropyl-aminoethyl chloride (free base) are added over 5 min to the alkali cellulose formed and the temperature is raised to 65° C. After a reaction time of 3 h, the highly viscous mass formed is taken up in water and mechanically comminuted. Salts and by-products are removed by intense washing. The nitrogen content determined by elemental analysis is 5.85% (DS=1.44).

### EXAMPLE 3

243 g (1.5 mol) of cellulose are alkalized in 5 l of 31% sodium hydroxide solution and the partially squeezed-off filter cake is then squeezed off again until the anhydroglucose:NaOH:water ratio is 1:4:20. After heating to 55° C., 600 g (3 mol) of N,N-diisopropylaminoethyl chloride hydrochloride are added in solid form and the mixture is kneaded intensely for 3 h at 40 min⁻¹. The reaction product is washed with water. The nitrogen content determined after drying is 5.45% (DS=1.26).

### EXAMPLE 4

595 ml of 17% sodium hydroxide solution are added to 169 g (1 mol) of N,N-dimethylaminoethyl cellulose (% N: 0.87-DS: 0.10), bringing the AGU:NaOH:water ratio to 1:3:32.5, and the mixture is then kneaded thoroughly. After heating to 80° C. in the kneader, 327 g (2 mol) of N,N-diisopropylaminoethyl chloride are added. After kneading for 4 hours, the reaction mixture is treated with ethanol/water (1:1 v/v) and neutralized with dilute hydrochloric acid. The polymer solubilized in this way is precipitated by the addition of NaOH, rinsed with acetone and dried. The nitrogen content is determined again and is now 6.03% (DS=1.22).

### EXAMPLE 5

327 g (2 mol) of N,N-diisopropylaminoethyl chloride are added to 162 g (1 mol) of wood pulp and the mixture is stored for 12 h at room temperature with the exclusion of air. 300 ml of 30% sodium hydroxide solution are then added and the batch is kneaded for 4 h at 60° C. The resulting reactant ratio in the liquor is as follows: anhydroglucose:NaOH:agent:water=1:3:2:15.5. When the reaction has ended, the product is squeezed off and washed repeatedly with water until the effluent wash water is almost neutral. After drying, the white product is granulated. The nitrogen content found by elemental analysis is 5.97% (DS=1.50).

### EXAMPLE 6

50% sodium hydroxide solution (6 mol) is added to 243 g (1.5 mol) of ground pulp containing atmospheric moisture, in a mixer, and the ingredients are mixed for 45 min. 3 mol of N,N-diisopropylaminoethyl chloride (65% solution) are added and the reaction is continued for a further 4 h. The resulting reactant ratio AGU:NaOH:agent:water in the reaction mixture is 1:4:2:21.5. The reaction product formed is separated from the excess reaction liquid by suction and washed with warm water until the pH of the effluent wash water remains constant. The white powder obtained after drying has a nitrogen content of 5.80% (DS=1.14).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A process for the preparation of cellulose derivatives containing amino groups comprising reacting, in the presence of water as a reaction medium, a cellulose selected from the group consisting of alkali cellulose and alkali cellulose derivative with a reagent represented by the following general formula,
X—(CH₂)ₙ—NR₁R₂
wherein,
X is selected from the group consisting of chlorine, bromine, iodine and a sulfonic acid radical R′SO₃, in which R′ is an aromatic radical or an aliphatic radical,
n is at least 2, and
R₁ and R₂ independently of each other are selected from the group consisting of aliphatic substituents, branched alkyl substituents, cyclic alkyl substituents, aryl substituents, aryl substituents substituted by heteroatoms, H, and R₁ and R₂ together form a ring with the nitrogen, R₁ and R₂ independently comprising 1-24 C-Atoms,
wherein the mole ratio of cellulose to water, of said reaction medium, is 1:5 to 1:40 mol water per mol of anhydroglucose unit (AGU).

2. The process of claim 1 furthering comprising reacting said cellulose with an etherifying agent, wherein the mole ratio of etherifying reagent to AGU is 0.1:1 mol to 3:1 mol.

3. The process of claim 1 of claim 1 wherein said cellulose derivative of said alkali cellulose derivative is a cellulose ether.

4. The process of claim 3 wherein said cellulose ether has an overall degree of substitution of between 0.01 and 4,
a mean degree of substitution of alkyl substituents (DS_{alkyl}) of between 0 and 2.5, and
a molar degree of substitution of hydroxyalkyl substituents (MS_{hydroxyalkyl}) of between 0 and 3.5.

5. The process of claim 2 wherein the mole ratio of etherifying reagent to AGU is 0.01:1 to 1.5:1.

6. The process of claim 1 wherein the ratio of cellulose to water is 1:10 to 1:30 mol per mol of anhydroglucose unit.

7. A cellulose derivative containing amino groups comprising:
a) substituents represented by the following formula,
—(CH₂)ₙ—NR₁R₂,
wherein R₁ and R₂ independently of each other are selected from the group consisting of aliphatic substituents, branched alkyl substituents, cyclic alkyl substituents, aryl substituents, aryl substituents substituted by heteroatoms, H, and R₁ and R₂ together form a ring with the nitrogen, R₁ and R₂ independently comprising 1-24 C-Atoms,
b) at least one alkyl substituent —R₃ represented by the formula
—(CH₂)ₘ—CH₃,
wherein,
m is 0 to 3, and
said cellulose derivative containing amino groups having a DS_{alkyl}>0.1, relative to said alkyl substituents —R₃,
wherein said cellulose derivative containing amino groups has an overall degree of substitution (sum of the individual degrees of substitution) of the substituents —(CH₂)ₙ—NR₁R₂ and —R₃ of between 0.8 and 2 per anhydroglucose unit, said overall degree of substitution being determined,
by measuring the nitrogen content (for substituents —(CH₂)ₙ—NR₁R₂), and by means of Zeisel cleavage (for substituents —R₃).

8. A cellulose derivative containing amino groups comprising:
a) substituents bonded directly to the cellulose or a cellulose side chain, the substituents being represented by the following formula,
—(CH₂)ₙ—NR₁R₂,
wherein,
n is at least 2, and
R₁ and R₂ independently of each other are selected from the group consisting of aliphatic substituents, branched alkyl substituents, cyclic alkyl substituents, aryl substituents, aryl substituents substituted by heteroatoms, H, and R₁ and R₂ together form a ring with the nitrogen,
b) at least one alkyl substituent —R₃ represented by the following formula,
—(CH₂)ₘ—CH₃,
wherein,
m is 0 to 3, and
said cellulose derivative containing amino groups having a DS_{alkyl}>0.1, relative to said alkyl substituents —R₃, and
c) at least one hydroxyalkyl substituent —R₄ represented by the following formula,
—CH₂—CH(CₚH₂ₚ₊₁)O—{CH₂—CH(CₚH₂ₚ₋₁)O}_{q}—CᵣH₂ᵣ₊₁,
wherein,
p is 0 or 1,
q is 0 to 30,
r is 0 or 1, and
said cellulose derivative containing amino groups having a MS_{hydroxyalkyl}>0.1, relative to said hydroxyalkyl substituents —R₄,
wherein said cellulose derivative containing amino groups has an overall degree of substitution (sum of the individual degrees of substitution) of the substituents —(CH₂)ₙ—NR₁R₂, —R₃ and —R₄ of between 0.8 and 2.5 per anhydroglucose unit, said overall degree of substitution being determined,
by measuring the nitrogen content (for substituents —(CH₂)ₙ—NR₁R₂), and by means of Zeisel cleavage (for substituents —R₃ and —R₄).

9. A cosmetic formulation comprising the cellulose derivative containing amino groups prepared by the method of claim 1.

10. An aqueous paper treatment composition comprising the cellulose derivative containing amino groups prepared by the method of claim 1.
